(19) United States
(12) Patent Application Publication
(10) Pub. No.: US 2026/0089780 A1
(43) Pub. Date: Mar. 26, 2026

(54) SYSTEMS AND METHODS FOR PASS-THROUGH COMMUNICATION BETWEEN DEVICES

(71) Applicant: Apple Inc., Cupertino, CA (US)

(72) Inventors: Vamshi Krishna Aileni, San Jose, CA (US); Paul B. Fruhauf, Santa Clara, CA (US)

(21) Appl. No.: 18/897,861

(22) Filed: Sep. 26, 2024

(51) Int. Cl. H04W 76/15; H04B 7/155; H04W 12/55

(52) U.S. Cl. CPC H04W 76/15; H04B 7/155; H04W 12/55

(57) ABSTRACT

An electronic device gathers (e.g., consolidates) information (e.g., passes, tickets, credentials) received via one or more pass-through communication sessions to transmit (e.g., present, provide, relay) to an authentication device. The electronic device may receive information from one or more additional electronic devices in a group with the electronic device via the pass-through communication sessions. The electronic device may then transmit the information to the authentication device. As such, the electronic device gathers the information from the group and presents the information from the one or more additional electronic device to the authentication device.

### BACKGROUND

The present disclosure relates generally to wireless communication, and more specifically pass-through communications.

In various environments, such as events, amusement parks, or secure facilities, an electronic device may be used to present authentication credentials, such as digital passes or tickets, to provide individual entry to a user. For example, the user may present their own electronic device with their own digital pass or ticket. While this process may simplify access for individuals, challenges may be present in group settings where multiple people, such as families or friends, arrive and intend to enter together. For example, it may be inefficient and burdensome on each user within the group to manage accessing an appropriate application, retrieving the digital pass, and/or presenting it for entry. Additionally or alternatively, each user managing and presenting their own digital pass may disrupt an intended pace of entry, which may impact an overall user experience.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a first user device includes a first transmitter, a second transmitter, a first receiver, a second receiver, and processing circuitry is coupled to the first transmitter, the second transmitter, the first receiver, and the second receiver. The processing circuitry is configured to cause the first transmitter to broadcast an identifier, establish a pass-through communication session with a second user device, cause the second receiver to receive a transaction command from a reader, cause the first transmitter to transmit the transaction command to the second user device via the pass-through communication session, cause the first receiver to receive a pass-through response from the second user device via the pass-through communication session, and cause the second transmitter to transmit the pass-through response to the reader.

In another embodiment, a method includes broadcasting, via processing circuitry, an identifier, establishing, via the processing circuitry, a pass-through communication session with a user device, and receiving, via the processing circuitry, a transaction command from a reader. The method also includes transmitting, via the processing circuitry, the transaction command to the user device via the pass-through communication session, receiving, via the processing circuitry, a pass-through response from the user device, and transmitting, via the processing circuitry, the pass-through response to the reader.

In yet another embodiment, one or more tangible, non-transitory computer-readable media store instructions that, when executed by processing circuitry, are configured to cause the processing circuitry to establish a pass-through communication session with a user device, receive a transaction command from a reader, transmit the transaction command to the user device, receive a pass-through response from the user device, and transmit the pass-through response to the reader.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of the electronic device of FIG. 1 in communication with an authentication device and in pass-through communication with additional electronic devices, according to embodiments of the present disclosure;

FIG. 4 is a schematic diagram of the electronic device of FIG. 1 forming a group with the additional electronic devices of FIG. 3, according to embodiments of the present disclosure;

FIG. 5 is a flowchart of a method for the electronic device of FIG. 1 to receive data from the additional electronic devices via pass-through communication sessions to transmit to the authentication device of FIG. 3, according to embodiments of the present disclosure; and

FIG. 6 is a flowchart of a method for the electronic device of FIG. 1 to receive credentials from an additional electronic device via a pass-through communication session to transmit to the authentication device of FIG. 3, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 % of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to techniques for gathering (e.g., consolidating) information (e.g., passes, tickets, credentials) received via one or more pass-through communication sessions to transmit (e.g., present, provide, relay) to an authentication device, such as a near-field communication (NFC) reader. An electronic device (e.g., primary or lead device) may employ the techniques described herein to receive the information from one or more additional electronic devices via the one or more pass-through communication sessions and transmit the information to the authentication device. For example, the electronic device may employ a provisioning server to provision (e.g., set up, configure) the electronic device and the one or more additional electronic devices on a network into a group. For example, the one or more additional electronic devices may include a first additional electronic device and a second additional electronic device.

The provisioning server may generate a group identification (group ID), such as a unique identifier, to represent the group and enable the electronic device, the first additional electronic device, and the second additional electronic device to identify themselves as a part of the group. Indeed, the provisioning server may assign (e.g., distribute) the group ID to each of the electronic device, the first additional electronic device, and the second additional electronic device to enable formation of the group. That is, the electronic device, the first additional electronic device, and the second additional electronic device may employ the group ID to identify advertisements intended for devices in the group. In an embodiment, the electronic device may employ post-provisioning via an external channel.

The electronic device may initiate a communication session, such as a transaction session, based on proximity to the authentication device. Moreover, the electronic device may broadcast an advertisement, which may include an identifier (e.g., a Bluetooth Universally Unique Identifier (UUID)) that is based on (e.g., the same as or derived from) the group ID. The first additional electronic device and the second additional electronic device that are a part of the group (e.g., and within a threshold distance of the electronic device, such as within a proximity to enable Bluetooth communication with the electronic device) may scan (e.g., listen) for the advertisement and transmit a connection request, which includes the identifier, to the electronic device based on the advertisement. The electronic device may then establish a first pass-through communication session with the first additional electronic device and a second pass-through communication session with the second additional electronic device based on the identifier.

For example, the electronic device may receive a first connection request from the first additional electronic device and verify (e.g., check) that the first connection request includes the identifier. The electronic device may then establish the first pass-through communication session with the first additional electronic device based on first connection request including the identifier. As another example, the electronic device may receive a second connection request from the second additional electronic device and verify that the second connection request includes the identifier. The electronic device may then establish the second pass-through communication session with the second additional electronic device based on the second connection request including the identifier.

The electronic device may receive a first transaction command from the authentication device. For example, the first transaction command may include a request for credentials associated with a digital pass of the first additional electronic device. Thus, the electronic device may relay a first pass-through command to the first additional electronic device (e.g., via the first pass-through communication session) based on the first transaction command. Moreover, the first additional electronic device may transmit a first pass-through response to the electronic device, which includes the credentials associated with the digital pass of the first additional electronic device. The electronic device may receive the first pass-through response and transmit a first transaction response including the credentials of the first additional electronic device to the authentication device. In an embodiment, after providing the first transaction response to the authentication device, the electronic device may disconnect from (e.g., end the first pass-through communication session with) the first additional electronic device.

The electronic device may then receive a second transaction command from the authentication device. As an example, the second transaction command may include a request for credentials associated with a digital pass of the second additional electronic device. As such, the electronic device may relay a second pass-through command to the second additional electronic device (e.g., via the second pass-through communication session) based on the second transaction command. Further, the second additional electronic device may transmit a second pass-through response to the electronic device, which includes the credentials associated with the digital pass of the second additional electronic device. The electronic device may receive the second pass-through response and transmit a second transaction response including the credentials of the second additional electronic device to the authentication device. In an embodiment, after providing the second transaction response to the authentication device, the electronic device may disconnect from (e.g., end the second pass-through communication session with) the second additional electronic device.

In an embodiment, the electronic device may be associated with an additional electronic device and may establish a pass-through communication session with the additional electronic device based on the association. For example, the electronic device may be associated with the additional electronic device based on being paired (e.g., via Bluetooth) either previously or presently with one another. As another example, the additional electronic device may be stored (e.g., in a list) on the electronic device as a device that the electronic device has paired with and/or is permitted to pair with. The electronic device may establish a pass-through communication session with the additional electronic device via an already existing channel (e.g., a Bluetooth link) between the electronic device and the additional electronic device.

The additional electronic device may store credentials, such as in a memory of the additional electronic device. The electronic device may receive a transaction command from the authentication device, which may include a request for the credentials stored at the additional electronic device. Moreover, the electronic device may transmit a pass-through command to the additional electronic device (e.g., via the pass-through communication session). The additional electronic device may transmit the pass-through response, which may include the credentials stored at the additional electronic device. As such, the electronic device may transmit a transaction response to the authentication device, which includes the credentials from the additional electronic device.

It should be noted that the electronic device may perform the techniques described herein any suitable number of times with any suitable number of additional electronic devices. In this manner, the electronic device may gather the information (e.g., the credentials associated with digital passes) from the additional electronic devices within the group or from the additional electronic devices associated with the user and present the information to the authentication device. In this manner, a single electronic device may be used in presenting multiple credentials to the authentication device in an efficient manner and/or improve an overall user experience.

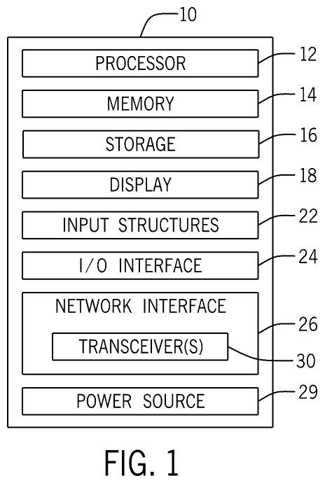

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH network, a local area network (LAN) or wireless local area network (WLAN), such as a network employing one of the IEEE 802.11x family of protocols (e.g., WI-FI), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, Long Term Evolution (LTE) cellular network, Long Term Evolution License Assisted Access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX), mobile broadband Wireless networks (mobile WIMAX), asynchronous digital subscriber lines (e.g., ADSL, VDSL), digital video broadcasting-terrestrial (DVB-T) network and its extension DVB Handheld (DVB-H) network, ultra-wideband (UWB) network, alternating current (AC) power lines, and so forth.

As illustrated, the network interface 26 may include one or more transceivers 30 (e.g., one or more Bluetooth transceivers). In some embodiments, all or portions of the transceiver 30 may be disposed within the processor 12. The transceiver 30 may support transmission and receipt of various wireless signals via one or more antennas, and thus may include a transmitter and a receiver. As will be discussed in greater detail below, the transceiver 30 may include various transceivers that facilitate communication with external devices over various types of communication protocols. For example, the transceiver 30 may perform cellular communication, Wi-Fi communication, NFC or other short-range communication such as UWB, and so on. The power source 29 of the electronic device 10 may include any suitable source of power, such as a rechargeable lithium polymer (Li-poly) battery and/or an alternating current (AC) power converter.

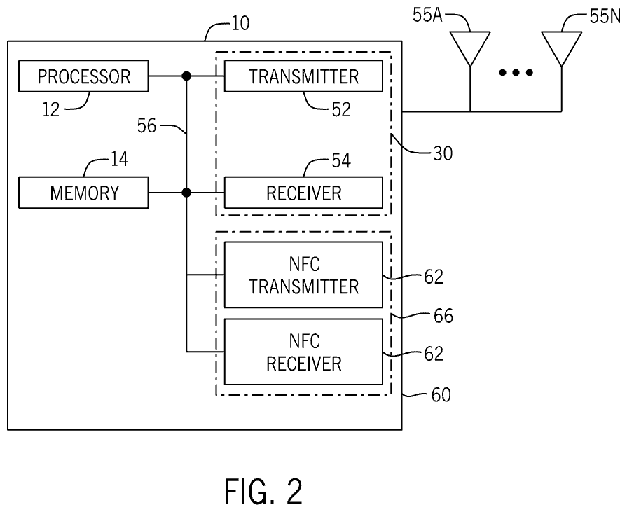

FIG. 2 is a functional diagram of the electronic device 10 of FIG. 1, according to embodiments of the present disclosure. As illustrated, the electronic device 10 may include multiple transceivers, such as a first transceiver 30 (having the transmitter 52 and the receiver 54) that may be employed for communicating using a first communication protocol or standard. For example, the first communication protocol or standard may include cellular communication via, for example, a cellular network (e.g., including base stations or access points) or a direct connection. As another example, the first communication protocol or standard may include Bluetooth communication protocols or standards. The electronic device 10 may also include an NFC transceiver 66 (having an NFC transmitter 62 and an NFC receiver 64) that may be employed for communicating using a second protocol or standard, such as an NFC communication protocol or standard. In some embodiments, the transceiver 30, 66 may be combined in a single transceiver, the transmitters 52, 62 may be combined in a single transmitter, and the receivers 54, 64 may be combined in a single receiver. Moreover, the transceiver 30 and the NFC transceiver 66 may be combined into a single transceiver. As illustrated, the processor 12, the memory 14, the transceiver 30, the transmitter 52, the receiver 54, the NFC transceiver 66, the NFC transmitter 62, the NFC receiver 64, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The electronic device 10 may also have one or more antennas 55A-55N electrically coupled to the transceivers 30 and/or 66. For example, a first set of antennas 55A-55N may be coupled to the transceiver 30 and a second set of antennas 55A-55N may be coupled to the transceiver 66. The antennas 55A-55N may be configured in an omnidirectional or directional configuration, in a single-beam, dual-beam, or multi-beam arrangement, and so on. Each antenna 55 may be associated with one or more beams and various configurations. In some embodiments, one or more antennas of the antennas 55A-55N of an antenna group or module may be communicatively coupled to a respective transceiver 30 and each may emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

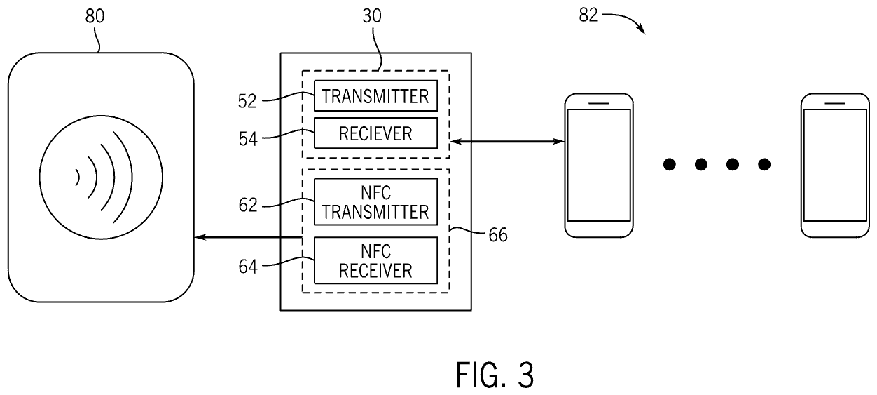

FIG. 3 is a schematic diagram of the electronic device of FIG. 1 in communication with an authentication device 80 and in pass-through communication with one or more additional electronic devices 82. The authentication device 80 may include a reader device, such as an NFC reader device, or any other suitable authentication device. The electronic device 10 may initiate a communication session (e.g., a transaction session) with the authentication device 80 based on a proximity (e.g., distance, range) to the authentication device 80. As an example, the authentication device 80 may emit a field (e.g., electromagnetic field) when powered on, which may detect nearby electronic devices within the proximity that are capable (e.g., NFC-capable) of communicating with the authentication device 80. The electronic device 10 may detect the field using the NFC receiver 64.

Additionally, the electronic device 10 may transmit a signal to the authentication device 80 using the NFC transmitter 62 to indicate its presence and ability to communicate. Further, the authentication device 80 may acknowledge the signal from the electronic device 10 and establish the communication session with the electronic device 10. In this manner, the electronic device 10 may exchange data or information (e.g., transaction commands and responses) with the authentication device 80 using the NFC transceiver 66 (e.g., the NFC transmitter 62 and the NFC receiver 64).

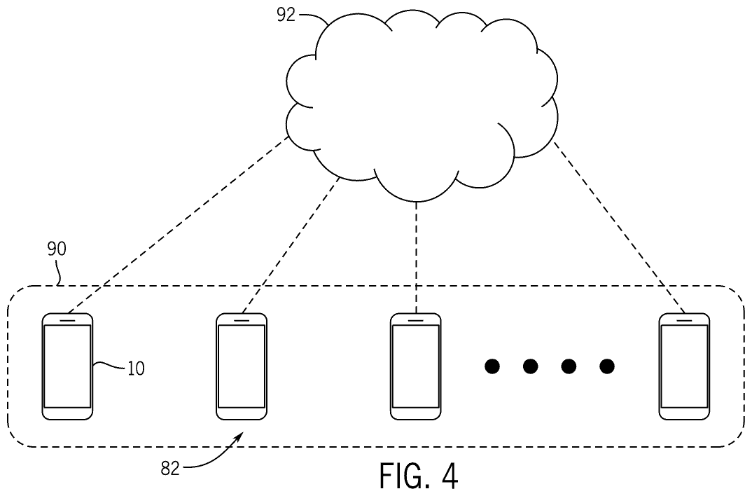

The electronic device 10 may also establish pass-through communication sessions with each of the one or more additional electronic devices 82. For example, the pass-through communication sessions may include Bluetooth communication sessions (e.g., using the transceiver 30). The electronic device 10 may broadcast an advertisement using the transmitter 52, which may include an identifier (e.g., a Bluetooth Universally Unique Identifier (UUID)) that is based on (e.g., same as or derived from) a group identification (ID) assigned to the electronic device 10 and the additional electronic devices 82. For example, as will be described in further detail below with respect to FIG. 4, a provisioning server may generate and assign the group ID to the electronic device 10 and the additional electronic devices 82 to enable formation of a group including the electronic device 10 and the additional electronic devices 82. Indeed, the electronic device 10 and the additional electronic devices 82 may employ the group ID to identify advertisements intended for the group, such as the electronic device 10 and the additional electronic devices 82.

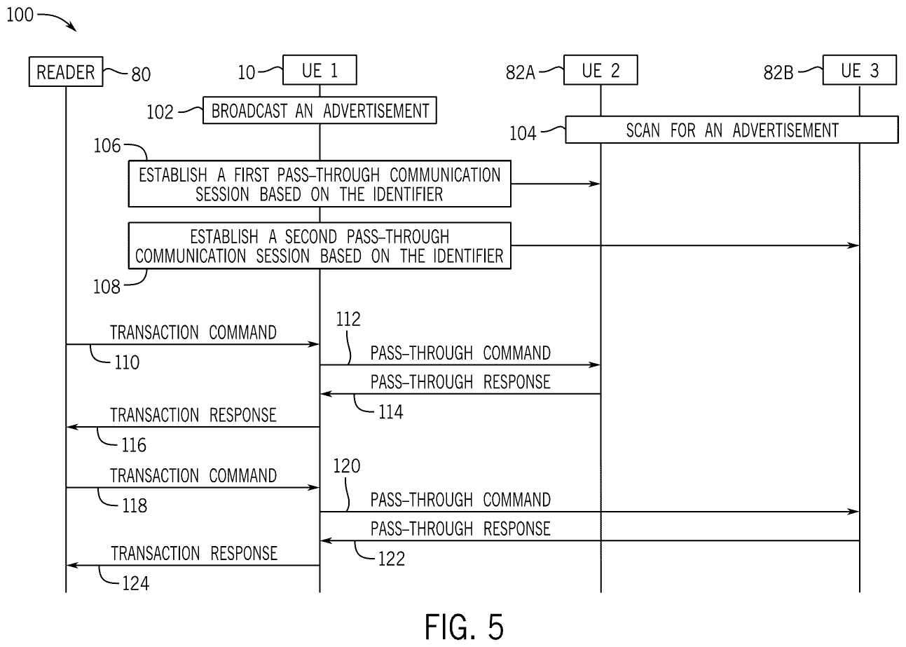

The additional electronic devices 82 that are a part of the group and within a threshold distance of the electronic device 10 (e.g., within a proximity to enable Bluetooth communication with the electronic device 10) may scan (e.g., listen) for the advertisement and transmit connection requests, which include the identifier, based on the advertisement. In some embodiments, the electronic device 10 may determine that the additional electronic devices 82 are within the threshold distance by employing Ultra-Wideband technology to determine the distance using a Time of Flight (ToF) measurement and comparing the distance to the threshold distance. Moreover, in an embodiment, the electronic device 10 may employ the Ultra-Wideband technology to perform secure ranging, which may include ensuring the distance is valid and secure (e.g., distance has not been tampered with or manipulated by any external devices) by employing security measures or authentication mechanisms. The electronic device 10 may receive the connection request from the additional electronic devices 82 using the receiver 54. In addition, as will be described in further detail below with respect to FIG. 5, the electronic device 10 may establish pass-through communication sessions with each of the additional electronic devices 82 based on the identifier.

The electronic device 10 may receive a transaction command from the authentication device 80 using the NFC receiver 64. For example, the transaction command may include a request for credentials associated with a digital pass of an additional electronic device 82. Therefore, the electronic device 10 may relay or forward the transaction command as a pass-through command to the additional electronic device 82 using the transmitter 52. The additional electronic device 82 may then provide a pass-through response, which may include the credentials, to the electronic device 10. For example, the additional electronic device 82 may encapsulate the pass-through response, which includes NFC data, within a Bluetooth packet.

The electronic device 10 may then receive the pass-through response from the additional electronic device 82 using the receiver 54. Thus, the electronic device 10 may receive the pass-through response and extract the NFC data from the Bluetooth packet to enable transmission to the authentication device 80. The electronic device 10 may then transmit the pass-through response as an NFC transaction response including the credentials to the authentication device 80 using the NFC transmitter 62. In an embodiment, the authentication device 80 may transmit the transaction command to the electronic device 10. In parallel (e.g., at a same or similar time), the electronic device 10 may retrieve credentials and/or any other transaction-related data from the additional electronic devices 82 to reduce or minimize a duration of the transaction, thereby improving overall efficiency in performance of the transaction. In this manner, the electronic device 10 may efficiently consolidate and present multiple credentials from the additional electronic devices 82 within the group to the authentication device 80 by employing pass-through communications.

With the foregoing in mind, FIG. 4 is a schematic diagram of the electronic device 10 of FIG. 1 forming a group 90 with the additional electronic devices 82. As described herein, a provisioning server 92 may generate the group ID to represent the group 90 and enable the electronic device 10 and the additional electronic device 82 to identify themselves as a part of the group 90. The electronic device 10 and/or the additional electronic devices 82 may initiate the provisioning server 92 to begin the provisioning process. For example, the electronic device 10 and/or the additional electronic devices 82 may broadcast their respective presence and/or contact the provisioning server 92 to connect to the provisioning server 92. In this manner, the electronic device 10 and/or the additional electronic devices 82 may employ the provisioning server 92 for set up and configuration of the group.

The provisioning server 92 may generate and distribute the group ID to represent the electronic device 10 and the additional electronic devices 82 as the group 90. In this manner, the additional electronic devices 82 may recognize and respond to communications, such as the advertisements from the electronic device 10, and commands, such as the pass-through commands from the electronic device 10. For example, the electronic device 10 may include the group ID or the identifier derived from the group ID in the advertisements to the additional electronic devices 82. In this manner, the additional electronic devices 82 may receive the advertisement and check for the group ID or the identifier to verify that the advertisement is relevant and execute an action based on the advertisement, such as the connection request. Indeed, the additional electronic devices 82 may recognize and respond to the communications and the commands based on the group ID. It should be noted that the provisioning server 92 may add or remove the additional electronic devices 82 at any suitable time.

FIG. 5 is a flowchart of a method 100 for the electronic device of FIG. 1 to receive data from the additional electronic devices via pass-through communication sessions to transmit to the authentication device 80 of FIG. 3. Any suitable device (e.g., a controller) that may control components of the electronic device 10, such as the processor 12, the transceiver 30, and/or the transceiver 66 may perform the method 100. In some embodiments, the method 100 may be implemented by executing instructions stored in a tangible, non-transitory, computer-readable medium, such as the memory 14 or the storage 16, using the processor 12, the transceiver 30, and/or the transceiver 66. For example, the method 100 may be performed at least in part by one or more software components such as an operating system of the electronic device 10, one or more software applications of the electronic device 10, and the like. While the method 100 is described using steps in a specific sequence, it should be understood that the present disclosure contemplates that the described steps may be performed in different sequences than the sequence illustrated, and certain described steps may be skipped or not performed altogether.

At process 102, the processor 12 of the electronic device 10 (e.g., first user equipment) broadcasts the advertisement via the Bluetooth transmitter 52. The advertisement may include the identifier that is based on (e.g., same as or derived from) the group ID. For example, the identifier may include the Bluetooth UUID, which may be a 128-bit identifier used in Bluetooth communication to identify services, characteristics, and/or any other suitable elements within Bluetooth protocols. At process 104, a processor of a first additional electronic device 82A (e.g., second user equipment) and a processor of a second additional electronic device 82B (e.g., third user equipment) scan for the advertisement via respective transceivers. As described herein, the processor of the first additional electronic device 82A may transmit a first connection request and the processor of the second additional electronic device 82B may transmit a second connection request to the electronic device 10 based on the advertisement via the respective transceivers.

At process 106, the processor 12 of the electronic device 10 establishes a first pass-through communication session (e.g., first Bluetooth communication session) with the first additional electronic device 82A based on the identifier via the Bluetooth transceiver 30. For example, the processor 12 the electronic device 10 may receive the first connection request via the Bluetooth receiver 54 and verify (e.g., check) that the first connection request includes the identifier. At process 108, the processor 12 of the electronic device 10 establishes a second pass-through communication session (e.g., second Bluetooth communication session) with the second additional electronic device 82B based on the identifier via the Bluetooth transceiver 30. For example, the processor 12 of the electronic device 10 may receive the second connection request via the Bluetooth receiver 54 and verify (e.g., check) that the second connection request includes the identifier.

At process 110, a processor of the authentication device 80 transmit a first transaction command to the electronic device 10. The first transaction command may include an instruction or request sent as a first NFC data packet to cause the electronic device 10 to initiate an action. For example, the first transaction command may include a request for the processor 12 of the electronic device 10 to transmit first credentials associated with a digital pass of the first additional electronic device 82A. At process 112, the processor 12 of the electronic device 10 transmits a first pass-through command to the first additional electronic device 82A via the Bluetooth transmitter 52. For example, the processor 12 of the electronic device 10 may receive the first transaction command and encapsulate the first transaction command in a format suitable for Bluetooth transmission, such as by wrapping the first transaction command in a first Bluetooth communication packet (e.g., Bluetooth wrapper). In this manner, the processor 12 of the electronic device 10 may relay the first transaction command, including first NFC request data, via the first pass-through communication session (e.g., the Bluetooth session) using the first pass-through command.

In an embodiment, the first transaction command may include a secure communication. The processor 12 of the electronic device 10 may encrypt or authenticate the first transaction command before transmission to the first additional electronic device 82A. For example, the processor 12 of the electronic device 10 may encrypt a payload of the first transaction command with a session key derived from the identifier (e.g., the UUID), keys from provisioning by the provisioning server 92, and/or a session random (e.g., random number generated during the communication session). As another example, the processor 12 of the electronic device 10 may employ a paired mechanism shared during provisioning to enable the communication channel (e.g., Bluetooth communication channel) to be secure. In this manner, the processor 12 of the electronic device 10 may prevent any other devices (e.g., third-party devices not within the group 90) from intercepting the first transaction command. It should be noted that the processor 12 of the electronic device 10 may encrypt or authenticate any other suitable Bluetooth communication to enable any communication between the electronic device 10 and the additional electronic devices 82 to be secure.

At process 114, the processor of the first additional electronic device 82A transmits a first pass-through response to the electronic device 10 via its transceiver. Indeed, the processor of the first additional electronic device 82A may receive the first pass-through command via its transceiver and extract (e.g., unwrap) the first NFC request data from the first pass-through command (e.g., in the form of a Bluetooth packet). After extracting the first NFC request data, the processor of the first additional electronic device 82A may process the first NFC request as if it had directly received the request from the authentication device 80. Thus, the first pass-through response may include first NFC response data that includes the first credentials associated with the digital pass of the first additional electronic device 82A. The processor of the first additional electronic device 82A may encapsulate the response by wrapping the first pass-through response in the Bluetooth communication packet to transmit back to the electronic device 10 via its transceiver.

At process 116, the processor 12 of the electronic device 10 transmits the transaction response to the authentication device 80 via the NFC transmitter 62. For example, the processor 12 of the electronic device 10 extracts the first NFC response data that includes the first credentials from the Bluetooth packet sent by the first additional electronic device 82A and transmits the first NFC response data to the authentication device 80 via the NFC transmitter 62.

At process 118, the processor of the authentication device 80 transmits a second transaction command to the electronic device 10. The second transaction command may include an instruction or request sent as a second NFC data packet to cause the processor 12 of the electronic device 10 to initiate an action. For example, the second transaction command may include a request for the processor 12 of the electronic device 10 to transmit second credentials associated with a digital pass of the second additional electronic device 82B. At process 120, the processor 12 of the electronic device 10 transmits a second pass-through command to the second additional electronic device 82B via the Bluetooth transmitter 52. For example, the processor 12 of the electronic device 10 may receive the second transaction command and encapsulate the second transaction command in the format suitable for Bluetooth transmission, such as by wrapping the second transaction command in a second Bluetooth communication packet (e.g., Bluetooth wrapper). In this manner, the processor 12 of the electronic device 10 may relay the second transaction command, including second NFC request data, via the second-pass through communication session using the second pass-through command. It should be noted that the second pass-through command may also include the secure communication (e.g., as described above with respect to process 112). Indeed, the processor 12 of the electronic device 10 may also encrypt or authenticate the second pass-through command before transmission to the second additional electronic device 82B to prevent any other devices from intercepting the second pass-through command.

At process 122, a processor of the second additional electronic device 82B transmits a second pass-through response to the electronic device 10 via its transceiver. Indeed, the processor of the second additional electronic device 82B may receive the second pass-through command and extract the second NFC request data from the second pass-through command. After extracting the second NFC request data, the processor of the second additional electronic device 82B may process the second NFC request as if it had directly received the request from the authentication device 80. Thus, the second-pass through response may include second NFC response data that includes the second credentials associated with the digital pass of the second additional electronic device 82B. The processor of the second additional electronic device 82B may encapsulate the response by wrapping the second pass-through response in the Bluetooth communication packet to transmit back to the electronic device 10 via its transceiver.

At process 124, the processor 12 of the electronic device 10 transmits the transaction response to the authentication device 80 via the NFC transmitter 62. For example, the processor 12 of the electronic device 10 extracts the second NFC response data that includes the second credentials from the Bluetooth packet sent by the second additional electronic device 82B and transmits the second NFC data to the authentication device 80 via the NFC transmitter 62. In this manner, the processor 12 of the electronic device 10 may efficiently consolidate and present multiple credentials from the additional electronic devices 82 within the group 90 to the authentication device 80 by employing the method 100. It should be noted that the electronic device 10 may perform the method 100 described herein with respect to FIG. 5 any suitable number of times with any suitable number of additional electronic devices 82.

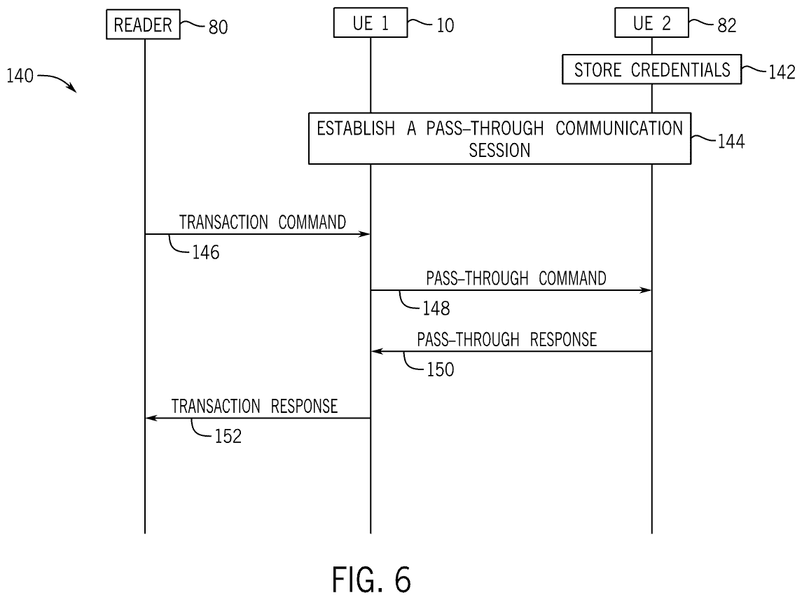

In an embodiment, the electronic device 10 may be associated with an additional electronic device 82 and may establish a pass-through communication session with the additional electronic device 82 based on the association. For example, the electronic device 10 may be associated with the additional electronic device 82 based on being paired (e.g., via Bluetooth) either previously or presently with the additional electronic device 82. As another example, the electronic device 10 may store (e.g., maintain) a record (e.g., a list) of other electronic devices, such as the additional electronic devices 82, that the electronic device 10 has interacted with (e.g., paired with and/or is permitted to pair with). In this manner, the electronic device 10 and the additional electronic device 82 may be associated by way of the additional electronic device 82 being stored in the record of the electronic device 10. Additional details regarding the electronic device 10 establishing a pass-through communication session with the associated additional electronic device 82 will be described below with respect to FIG. 6.

FIG. 6 is a flowchart of a method 140 for the electronic device of FIG. 1 to receive credentials from the additional electronic device 82 via a pass-through communication session to transmit to the authentication device 80 of FIG. 3. Any suitable device (e.g., a controller) that may control components of the electronic device 10, such as the processor 12, the transceiver 30, and/or the transceiver 66 may perform the method 140. In some embodiments, the method 140 may be implemented by executing instructions stored in a tangible, non-transitory, computer-readable medium, such as the memory 14 or the storage 16, using the processor 12, the transceiver 30, and/or the transceiver 66. For example, the method 140 may be performed at least in part by one or more software components such as an operating system of the electronic device 10, one or more software applications of the electronic device 10, and the like. While the method 140 is described using steps in a specific sequence, it should be understood that the present disclosure contemplates that the described steps may be performed in different sequences than the sequence illustrated, and certain described steps may be skipped or not performed altogether.

At process 142, a processor of the additional electronic device 82 stores credentials, such as in a memory of the additional electronic device 82. For example, the credentials may include a unique identification number, an access token, or any other suitable type of NFC credential. The processor of the additional electronic device 82 may employ the credentials when in proximity to the authentication device 80 for authentication and/or to obtain access to a secure environment. At process 144, the processor 12 of the electronic device 10 establishes a pass-through communication session with the additional electronic device 82 via the Bluetooth transceiver 30. As described herein, the electronic device 10 may be associated with the additional electronic device 82. Thus, the processor 12 of the electronic device 10 may establish the pass-through communication session by employing an existing link (e.g., Bluetooth link) between the electronic device 10 and the additional electronic device 82. In an embodiment, the processor 12 of the electronic device 10 may establish the pass-through communication session by employing an Application Programming Interface (API) that facilitates direct data transmission between the electronic device 10 and the additional electronic device 82.

At process 146, the processor of the authentication device 80 transmits a transaction command to the electronic device 10. The transaction command may include an instruction or request sent as an NFC data packet to cause the processor 12 of the electronic device 10 to retrieve the credentials of the additional electronic device 82. At process 148, the processor 12 of the electronic device 10 transmits a pass-through command to the additional electronic device 82 via the Bluetooth transmitter 52. For example, the processor 12 of the electronic device 10 may receive the transaction command and encapsulate the transaction command in a Bluetooth communication packet. As such, the processor 12 of the electronic device 10 may relay the transaction command, including NFC request data, via the pass-through communication session using the pass-through command.

At process 150, the processor of the additional electronic device 82 transmits a pass-through response to the electronic device 10 via its transceiver. Indeed, the processor of the additional electronic device 82 may receive the pass-through command and extract the NFC request data from the pass-through command. Accordingly, the pass-through response may include NFC response data that includes the credentials stored on the additional electronic device 82. For example, the processor of the additional electronic device 82 may encapsulate the response by wrapping the pass-through response in the Bluetooth communication packet to transmit to the electronic device 10.

At process 152, the processor 12 of the electronic device 10 transmits the transaction response to the authentication device 80 via the NFC transmitter 62. For example, the processor 12 of the electronic device 10 extracts the NFC response data that includes the credentials from the Bluetooth packet sent by the additional electronic device 82 and transmits the NFC response data to the authentication device 80 via the NFC transmitter 62. It should be noted that the electronic device 10 may perform the method 140 described herein with respect to FIG. 6 any suitable number of times with any suitable number of additional electronic devices 82. In this manner, the electronic device 10 may receive and employ the credentials stored on the additional electronic device 82 by employing an already existing connection and/or association between the electronic device 10 and the additional electronic device 82.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A first user device comprising:
a first transmitter;
a second transmitter;
a first receiver;
a second receiver; and
processing circuitry coupled to the first transmitter, the second transmitter, the first receiver, and the second receiver, the processing circuitry configured to:
cause the first transmitter to broadcast an identifier;
establish a pass-through communication session with a second user device;
cause the second receiver to receive a transaction command from a reader;
cause the first transmitter to transmit the transaction command to the second user device via the pass-through communication session;
cause the first receiver to receive a pass-through response from the second user device via the pass-through communication session; and
cause the second transmitter to transmit the pass-through response to the reader.

2. The first user device of claim 1, wherein the processing circuitry is configured to cause the first receiver to receive a connection request from the second user device based on the identifier.

3. The first user device of claim 1, wherein the processing circuitry is configured to:
determine the second user device within a threshold distance; and
establish the pass-through communication session based on the second user device being within the threshold distance.

4. The first user device of claim 3, wherein the processing circuitry is configured to determine the second user device is within the threshold distance via Ultra-Wideband technology.

5. The first user device of claim 1, wherein the pass-through communication session comprises a Bluetooth communication session.

6. The first user device of claim 1, wherein the pass-through response comprises near field communication (NFC) data encapsulated within a Bluetooth transmission.

7. The first user device of claim 6, wherein the processing circuitry is configured to extract the NFC data from the Bluetooth transmission of the second user device.

8. The first user device of claim 7, wherein the processing circuitry is configured to cause the second transmitter to transmit the NFC data to the reader.

9. The first user device of claim 1, wherein the first user device and the second user device are a part of a group, and wherein the group is associated with a group identification.

10. The first user device of claim 9, wherein the identifier is based on the group identification.

11. The first user device of claim 1, wherein the identifier comprises a Universally Unique Identifier (UUID), and wherein the UUID is 128-bit number.

12. The first user device of claim 1, wherein the processing circuitry is configured to establish the pass-through communication session with the second user device based on a contact list comprising the second user device.

13. The first user device of claim 1, wherein the processing circuitry is configured to:
establish an additional pass-through communication session with a third user device;
cause the second receiver to receive an additional transaction command from the reader;
cause the first transmitter to transmit the additional transaction command to the third user device via the additional pass-through communication session;
cause the first receiver to receive an additional pass-through response from the third user device; and
cause the second transmitter to transmit the additional pass-through response to the reader.

14. A method comprising:
broadcasting, via processing circuitry, an identifier;
establishing, via the processing circuitry, a pass-through communication session with a user device;
receiving, via the processing circuitry, a transaction command from a reader;
transmitting, via the processing circuitry, the transaction command to the user device via the pass-through communication session;
receiving, via the processing circuitry, a pass-through response from the user device; and
transmitting, via the processing circuitry, the pass-through response to the reader.

15. The method of claim 14, comprising receiving, via the processing circuitry, a connection request from the user device based on the identifier.

16. The method of claim 14, wherein the pass-through communication session comprises a Bluetooth communication session.

17. One or more tangible, non-transitory computer-readable media storing instructions that, when executed by processing circuitry, are configured to cause the processing circuitry to:
establish a pass-through communication session with a user device;
receive a transaction command from a reader;
transmit the transaction command to the user device;
receive a pass-through response from the user device; and
transmit the pass-through response to the reader.

18. The one or more tangible, non-transitory computer-readable media of claim 17, wherein the transaction command comprises a request for credentials, and wherein the pass-through response comprises an indication of the credentials.

19. The one or more tangible, non-transitory computer-readable media of claim 18, wherein the indication comprises near field communication data.

20. The one or more tangible, non-transitory computer-readable media of claim 17, wherein the instructions, when executed by the processing circuitry, are configured to cause the processing circuitry to establish the pass-through communication session with the user device via an Application Programming Interface.
